(19) United States
(12) Patent Application Publication
(10) Pub. No.: US 2026/0238238 A1
(43) Pub. Date: Aug. 13, 2026

(54) COOLING ARRANGEMENT FOR COOLING A RADIO EQUIPMENT IN A WIRELESS TELECOMMUNICATIONS NETWORK AND METHOD FOR MANUFACTURING A COOLING ARRANGEMENT

(71) Applicant: Telefonaktiebolaget LM Ericsson (publ), Stockholm (SE)

(72) Inventors: Catrin BENGTSON, Danderyd (SE); Johan JONSSON, Huddinge (SE); Henrik MARCOLLA, Sollentuna (SE)

(21) Appl. No.: 19/471,491

(22) PCT Filed: Apr. 6, 2023
(86) PCT No.: PCT/EP2023/059118

§ 371 Date: Oct. 1, 2025

(51) Int. Cl. H04B 1/036; G06F 1/20

(52) U.S. Cl. CPC H04B 1/036; G06F 1/20

(57) ABSTRACT

A cooling arrangement (130) for cooling a radio equipment (111) in a wireless telecommunications network is provided. The cooling arrangement is any one out of: An Additive Manufacturing, AM, metal printed heat sink, or a heat exchanger. The cooling arrangement (130) is characterized by comprising a shape of a Triple Periodic Minimal Surfaces, TPMS, structure (140). The TPMS structure comprises a surface area for meeting a fluid to achieve the cooling.

### TECHNICAL FIELD

Embodiments herein relate to a cooling arrangement and a method to manufacture the cooling arrangement. In some aspects, the cooling arrangement relates to cooling a radio equipment in a wireless telecommunications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5GC is core network, NR is radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

Today cooling equipment such as e.g. heat sinks and heat exchangers, on radio equipment are used to cool radio equipment such as base stations, radios and antennas etc. in wireless telecommunications networks. In the wireless telecommunications networks, there are size and weight limitations to lodge the cooling equipment and further there is a high demand for a low power consumption for the cooling equipment in the base stations, radios, and antennas. However, a problem todays' efficient cooling equipment may have quite a high weight, a large size and/or a high power consumption. A such cooling equipment is shown in FIG. 1. The cooling equipment in FIG. 1 is a convection cooled diecast heatsink with a traditional straight fin from a radio head product.

### SUMMARY

As a part of developing embodiments herein a problem was identified by the inventors and will first be discussed.

The Gyroid is a mathematical geometric shape. A gyroid is an infinitely connected Triple periodic minimal surface. It may arise as an interface with high surface area. It has been difficult to manufacture patterns, so called lattices, of Gyroids structures, until recently when Additive Manufacturing (AM) Metal Printers made it possible. AM or Additive Layer Manufacturing (ALM) is an industrial production name for 3D printing comprising a computer-controlled process that creates three dimensional objects by depositing materials, usually in layers. A gyroid lattice structure is a Triple Periodic Minimal Surface (TPMS)

A TPMS shape may e.g. comprise shapes such as a Gyroids, Diamond, Schwarz P, Schwarz D, Schwarz G, Neovius, Icosahedron, Lidinoid, SplitP, IWP, FRD, or FKS.

Today for example helmets, shoes, bicycle parts, helicopter heat exchanger for aircraft industry are produced by using gyroid. Samples can be seen on internet pictures and in showrooms at the AM producers' facilities.

However, Gyroids lattice as heat sinks and heat exchangers are not shown, included in or evaluated for Telecom Industry Hardware Products.

An object of embodiments herein is to provide an improved a cooling arrangement for radio equipment in a wireless telecommunications network.

According to another aspect of embodiments herein, the object is achieved by a cooling arrangement for cooling a radio equipment in a wireless telecommunications network. The cooling arrangement is any one out of: An Additive Manufacturing, AM, metal printed heat sink, or a heat exchanger.

The cooling arrangement is characterized by comprising a shape of a Triple Periodic Minimal Surfaces, TPMS, structure. The TPMS structure comprises a surface area for meeting a fluid to achieve the cooling.

According to another aspect of embodiments herein, the object is achieved by a method for manufacturing a cooling arrangement for cooling a radio equipment in a wireless telecommunications network. The cooling arrangement is any one out of: an Additive Manufacturing, AM, metal printed heat sink, or a heat exchanger. The method of manufacturing of the cooling arrangement is characterized by shaping the cooling arrangement with a Triple Periodic Minimal Surfaces, TPMS, structure, which TPMS structure comprises a surface area for meeting a fluid to achieve the cooling.

Thanks to that the cooling arrangement is shaped with TPMS structure comprising a large surface area for meeting a fluid to achieve the cooling in the radio equipment, the radio equipment together with the cooling arrangement can be made with a smaller size, and a lighter weight. This results in an improved cooling arrangement for the radio equipment in a wireless telecommunications network, or, improved cooling with the same size and/or weight.

Advantages of embodiments herein are e.g. that they improve the large delay issue and significantly improve flexibility and cost efficiency of the indoor deployment.

### BRIEF DESCRIPTION OF THE DRAWINGS

Examples of embodiments herein are described in more detail with reference to attached drawings in which:

FIG. 1 is a schematic picture illustrating prior art.

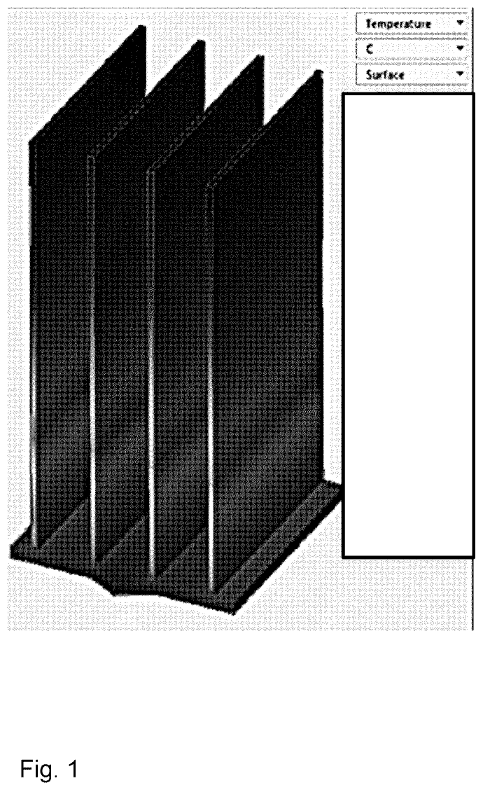

FIG. 2 is a schematic block diagram illustrating embodiments of a wireless telecommunications network.

FIG. 3 is a schematic block diagram illustrating embodiments of a cooling arrangement for cooling radio equipment.

FIG. 4 is a flowchart depicting an embodiment of a method for manufacturing the cooling arrangement.

### DETAILED DESCRIPTION

The weight, size and power are important parameters for base stations, radios and antennas. This balance can be affected by embodiments herein providing AM Metal Printed Heatsink or Heat exchangers with the shape called Triple Periodic Minimal Surfaces (TPMS) structure, e.g. a gyroid. The TPMS structure comprises a large surface area for meeting a fluid to achieve cooling. The large surface area that meets air, forced air or liquids for cooling is one parameter to consider. Embodiments herein provide TPMS structure for Heat sinks or Heat exchangers on radio equipment such as e.g., base stations, radio heads and antennas in order to reduce weight, reduce size and/or increase power.

By using TPMS shape structure, e.g., Gyroids shape lattices, the radio equipment, such as base station or antenna, budget for weight, size or power dissipation can be balanced in more effective ways.

Advantages of embodiments herein e.g. comprises the following:
Smaller size of a radio equipment is achieved using TPMS structure shaped metal printed heatsink.

Lighter weight of radio equipment is achieved using TPMS structure shaped metal printed heatsink.

Keeping the same size and weight of radio equipment, the insertion of TPMS structure shaped metal printed heatsink can handle higher power dissipation from increased heat sources.

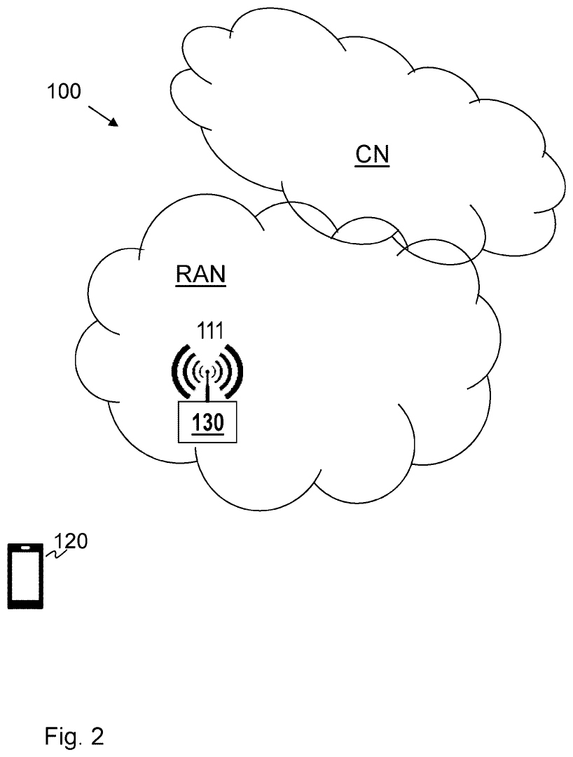

FIG. 2 is a schematic overview depicting a wireless telecommunications network 100, such as e.g. a wireless communications network, comprising radio equipment 111 wherein embodiments herein may be implemented. The wireless telecommunications network 100 comprises one or more RANs and one or more CNs. The wireless telecommunications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Radio equipment, such as a radio equipment 111 operates in the wireless telecommunications network 100. The radio equipment 111 may e.g. be a base station, a radio unit, a base band unit, an antenna tower, an antenna pole, an antenna and/or any other radio equipment. The radio equipment 111 generates heat and needs to be cooled down. It therefore comprises, e.g., is equipped with, a cooling arrangement 130 according to embodiments herein. The cooling arrangement may e.g. be a part of the radio equipment as e.g. fins, baseplates, cooling plates, coins, metal inserts, copper inserts, metal Thermal Interface Material (TIM) s, metal lids on electronic components (hotspots), vapor chambers, heat pipes, pipes, tubes, internal channels near the silicon and/or fans and/or thermosiphons and/or liquid cooling with external or internal heat exchangers or it's attachment devices such as brackets mast, pole, roof top, wall mount used outdoor and/or indoor or inside cabinets or vehicles. The cooling arrangement 130 will be described more in detail below.

The radio equipment 111 e.g. in some embodiments a base station that may be a transmission and reception point e.g. a radio access network node such as a base station, a radio base station, a NodeB, an evolved Node B (eNB, eNodeB, eNode B), an NR/g Node B (gNB), a part of an Indoor Radio Unit (IRU), an Open RAN (ORAN) node, a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the network node 110 depending e.g. on the radio access technology and terminology used.

UEs, such as e.g. a UE 120, operate in the wireless telecommunications network 100. The UE 120 may e.g. be an NR device, a mobile station, a wireless terminal, an IoT device, an IoS device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, a Vehicle-to-Network (V2N) device, a Wi-Fi device, an LTE device, a non-access point (non-AP) STA, a STA, that communicates via a base station such as e.g. the network node 110, and one or more Access Networks (AN), e.g. RAN, to one or more core networks (CN). It should be understood by the skilled in the art that the term UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

A number of embodiments will now be described, some of which may be seen as alternatives, while some may be used in combination.

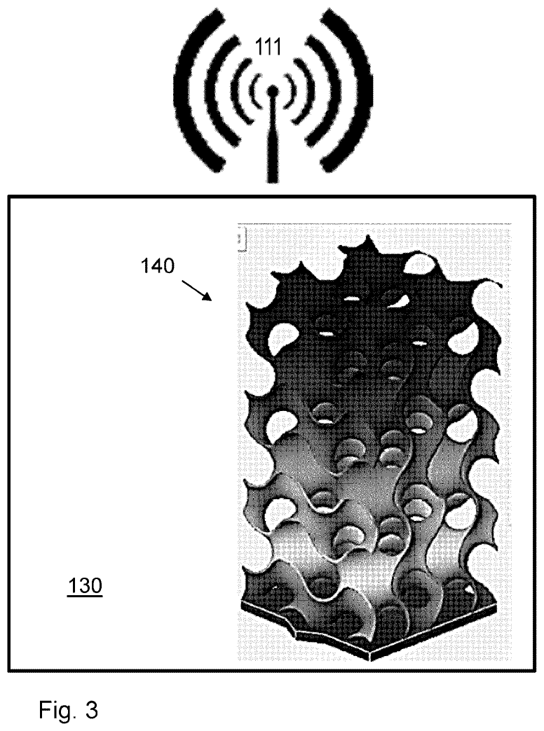

FIG. 3 very schematically depicts the radio equipment 111 and an example of the cooling arrangement 130 for cooling the radio equipment 111. As mentioned above, the radio equipment 111 may be represented by any one out of: a base station, a radio unit, a base band unit, an antenna tower, an antenna pole, and/or an antenna.

The cooling arrangement 130 is for cooling the radio equipment 111 in the wireless telecommunications network 100. As mentioned above, the cooling arrangement 130 is any one out of an AM metal printed heat sink, or a heat exchanger. An AM metal printed heat sink will be described below.

According to embodiments herein, the cooling arrangement 130 comprises a shape of a TPMS structure 140. Thus the AM Metal Printed Heatsink or Heat exchanger has a shape called TPMS structure, an example of the TPMS structure 140 is depicted in FIG. 3. The TPMS structure 140 comprises a surface area for meeting a fluid to achieve the cooling.

By using a TPMS structure 140 for shaping the cooling arrangement 130, it is enabled to a achieve a balance between desired parameters, such as e.g. predetermined parameters. These parameters may, e.g. comprise weight, size and power, which are important parameters for the radio arrangement 111 such as e.g., the base stations, the radios and the antennas. This is since the TPMS structure may have a large surface area and intertwining channels which may have good cooling characteristics. Also the TPMS structure has good AM characteristics, since it is self-supporting and requires little or no support material, which reduces the need for post processing. The large surface area that meets air, forced air or liquids for cooling is one parameter to consider when manufacturing the cooling equipment. Embodiments herein provide the usage of TPMS structure 140 such as Gyroids for heat sinks or heat exchangers on base stations, radios and antennas in order to reduce weight, reduce size or increase power. An increased power gives the effect of increased heat and increased need for cooling.

In some embodiments, the TPMS structure 140 is shaped to achieve the predetermined balance of parameters of the cooling arrangement 130. In some other embodiments, the TPMS structure 140 is shaped to achieve a predetermined balance of parameters of the radio equipment 111 together with the cooling arrangement 130.

This means that in some embodiments, the TPMS structure 140 is shaped to achieve the predetermined balance of parameters of any one out of: the cooling arrangement 130, or the radio equipment 111 together with the cooling arrangement 130.

In these embodiments the parameters may comprise at least one or more out of: component margin, temperature, a weight, volume, size, and/or power of the radio equipment 111 or the radio equipment 111 together with the cooling arrangement 130.

This e.g., means that by designing fins with TPMS, if locking the cooling surface area parameter, the volume the fins are consuming inside the overall radio size, will be less than designing with traditional fins, if equal amount of surface area.

Likewise, by designing fins with TPMS, if locking the fins weight parameter which is correlated to the fluid space in between the fins, the surface area will be higher than designing with traditional fins, if equal weight and/or fluid spacing. This means that for the same volume, fins are consuming inside the overall radio size, the efficiency of cooling increase.

Different characteristics of the TPMS structure 140 may be adapted to achieve desired balance of parameters, such as the predetermined balance of parameters. The characteristics of the TPMS structure 140 may e.g., comprise the surface area of the TPMS, a wall thickness of the TPMS, a size of the TPMS, and/or density and/or orientation of the TPMS. In these embodiments, the TPMS structure 140 that achieves the predetermined balance of parameters comprises the TPMS characteristics of the TPMS structure 140 the achieves the predetermined balance of parameters. This may mean that it is the characteristics of the TPMS structure 140 that are adapted to make the TPMS structure 140 achieve the predetermined balance of parameters.

The TPMS characteristics may relate to any one or more out of: a surface area of the TPMS, a wall thickness of the TPMS, a size of the TPMS, and/or density and/or orientation of the TPMS repeatability. This may mean that it is the characteristics of the TPMS structure 140 such as the surface area of the TPMS, a wall thickness of the TPMS, a size of the TPMS, and/or density and/or orientation of the TPMS repeatability that are adapted to make the TPMS structure 140 achieve the predetermined balance of parameters.

In some embodiments, the fluid comprises any one or more out of liquid and/or air. This means that the fluid, also referred to as cooling fluid, may be liquid, air or both liquid and air. In these embodiments, the shape of the TPMS characteristics comprises that the surface area of the TPMS structure 140 for meeting the fluid to achieve the cooling comprises that cooling channels are shaped with any one out of: cooling channels for liquid, cooling channels for air, or both cooling channels for liquid and cooling channels for air.

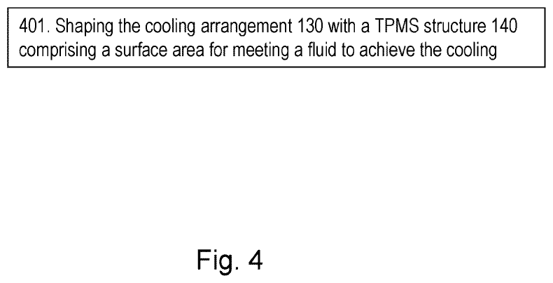

FIG. 4 shows an example embodiment of a method for manufacturing the cooling arrangement 130 for cooling the radio equipment 111 in the wireless telecommunications network 100. The radio equipment 111 may e.g., be represented by any one out of: A base station, a radio unit, a base band unit, an antenna tower, an antenna pole, and/or an antenna.

The cooling arrangement 130 is any one out of: an AM metal printed heat sink, or a heat exchanger, method performed by the network node 110. The method is for

The manufacturing of the cooling arrangement 130 method comprises the following action.

### Action 401

The cooling arrangement 130 is shaped with a TPMS structure 140. The TPMS structure 140 comprises a surface area for meeting a fluid to achieve the cooling. In other words, the TPMS structure 140 is shaped with a surface area for meeting a fluid to achieve the cooling. The fluid may comprise any one or more out of liquid and/or air. In other words, the fluid may be liquid, or air, or liquid and air.

The shaping of the TPMS structure 140 may be performed by AM metal printing the cooling arrangement with the TPMS structure 140.

The shaping of the cooling arrangement 130 with TPMS structure 140 may be performed by shaping the TPMS structure 140 such that a predetermined balance of parameters is achieved. These parameters may be parameters of any one out of: The cooling arrangement 130, or the radio equipment 111 together with the cooling arrangement 130.

The parameters may comprise at least one or more out of: Component margin, temperature, weight, volume, size, and/or power of the radio equipment 111 or the radio equipment 111 together with the cooling arrangement 130.

The shaping of the TPMS structure 140 may be performed by shaping TPMS characteristics of the TPMS structure 140. The TPMS characteristics may relate to any one or more out of: a surface area of the TPMS, a wall thickness of the TPMS, size of the TPMS, and/or density and/or orientation of the TPMS repeatability such that the predetermined balance of parameters of the radio equipment 111 is achieved.

There may be many different alternatives to vary the shaping of the TPMS characteristics to affect the parameters for meeting the balance of the predetermined balance of parameters.

In the shaping of the TPMS characteristics of the TPMS structure 140, the shaping of the TPMS characteristics may e.g., affect parameters as follows:
a thinner wall thickness of the TPMS,
a thicker wall thickness of the TPMS,
a variable wall thickness of the TPMS,
a manipulated wall thickness of the TPMS, from using any simulation result data as input,
a lower size of the TPMS structure 140,
a wider size of the TPMS structure 140,
a skewed size of the TPMS structure 140,
a rotated size of the TPMS structure 140,
a adjusted size of the TPMS structure 140,
a angled size of the TPMS structure 140,
a lower density of the repeatability of the TPMS structure 140,
a higher density of the repeatability of the TPMS structure 140,
a higher surface area of the TPMS structure 140,
a lower surface area of the TPMS structure 140,
a stretched in any direction lattice of the TPMS structure 140 shape,
a rectangular lattice of the TPMS structure 140 shape,
a circular lattice of the TPMS structure 140 shape,
a spherical lattice of the TPMS structure 140 shape,
an angular lattice of the TPMS structure 140 shape,
a manipulated lattice of the TPMS structure 140 shape, from using any simulation result data as input,

Individual and/or combinations of TPMS shaping in various ways, are associated with a lower and/or higher weight, volume, and/or size of the radio equipment 111 and/or is associated with a better fluid performance of liquid flow in any direction and a cooling to a lower temperature of the radio equipment 111 and/or better DfAM (Design for Additive Manufacturing) meaning less machine time spent on support structures.

As mentioned above, the fluid may comprise any one or more out of liquid and/or air. The shaping of the TPMS characteristics of the TPMS structure 140 such that the predetermined balance of parameters of the radio equipment 111 is achieved may further comprise to shape the surface area of the TPMS structure 140 for meeting the fluid. This may be performed by shaping cooling channels according to any one out of: Cooling channels for liquid, cooling channels for air, or both cooling channels for liquid and cooling channels for air.

Embodiments herein such as the embodiments mentioned above will now be further described and exemplified. The text below is applicable to and may be combined with any suitable embodiment described above.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

| Abbreviation | Explanation |
|---|---|
| AM | Additive Manufacturing |
| TPMS | Triple Periodic Minimal Surfaces |
| CFD | Computational Fluid Dynamics |
| W/m*m*K | Watt per Square meter Kelvin |
| MCAD | Mechanical Computer-Aided Design |

1. A cooling arrangement for cooling a radio equipment in a wireless telecommunications network, which cooling arrangement is any one out of: an Additive Manufacturing, AM, metal printed heat sink, or a heat exchanger, and
wherein the cooling arrangement is characterized by comprising a shape of a Triple Periodic Minimal Surfaces, TPMS, structure, which TPMS structure comprises a surface area for meeting a fluid to achieve the cooling.

2. The cooling arrangement according to claim 1, wherein the TPMS structure is shaped to achieve a predetermined balance of parameters of any one out of:
the cooling arrangement, or the radio equipment together with the cooling arrangement,
which parameters comprise at least one or more out of: component margin, temperature, weight, volume, size, and/or power of the radio equipment or the radio equipment together with the cooling arrangement.

3. The cooling arrangement according to claim 2, wherein the TPMS structure shape achieving the predetermined balance of parameters, comprises TPMS characteristics of the TPMS structure, which TPMS characteristics relate to any one or more out of: a surface area of the TPMS, a wall thickness of the TPMS, a size of the TPMS, and/or density and/or orientation of the TPMS repeatability.

4. The method according to claim 1, wherein the fluid comprises any one or more out of liquid and/or air, and wherein the shape of the TPMS characteristics comprises that the surface area of the TPMS structure for meeting the fluid to achieve the cooling comprises cooling channels that are shaped with any one out of:
cooling channels for liquid
cooling channels for air, or
both cooling channels for liquid and cooling channels for air.

5. The cooling arrangement according to claim 1, wherein the radio equipment is represented by any one out of: a base station, a radio unit, a base band unit, an antenna tower, an antenna pole, and/or an antenna.

6. A method for manufacturing a cooling arrangement for cooling a radio equipment in a wireless telecommunications network, wherein the cooling arrangement is any one out of: an Additive Manufacturing, AM, metal printed heat sink, or a heat exchanger, and wherein the method for manufacturing the cooling arrangement is characterized by:
shaping the cooling arrangement with a Triple Periodic Minimal Surfaces, TPMS, structure, which TPMS structure comprises a surface area for meeting a fluid to achieve the cooling.

7. The method according to claim 6, wherein the shaping of the cooling arrangement comprises shaping the TPMS structure such that a predetermined balance of parameters is achieved, which parameters comprise any one out of:
the cooling arrangement, or the radio equipment together with the cooling arrangement,
which parameters comprise at least one or more out of: component margin, temperature, weight, volume, size, and/or power of the radio equipment or the radio equipment together with the cooling arrangement.

8. The method according to claim 7, wherein the shaping of the TPMS structure comprises: shaping TPMS characteristics of the TPMS structure, relating to any one or more out of: a surface area of the TPMS, a wall thickness of the TPMS, size of the TPMS, and/or density and/or orientation of the TPMS repeatability such that the predetermined balance of parameters of the radio equipment is achieved.

9. The method according to claim 6, wherein the fluid comprises any one or more out of liquid and/or air, and wherein in the shaping of the TPMS characteristics of the TPMS structure such that the predetermined balance of parameters of the radio equipment is achieved further comprises:
shaping the surface area of the TPMS structure for meeting the fluid to achieve the cooling by shaping cooling channels according to any one out of:
cooling channels for liquid,
cooling channels for air, or
both cooling channels for liquid and cooling channels for air.

10. The method according to claim 6, wherein the radio equipment is represented by any one out of: a base station, a radio unit, a base band unit, an antenna tower, an antenna pole, and/or an antenna.
